(19) United States
(12) Patent Application Publication
(10) Pub. No.: US 2011/0231755 A1
(43) Pub. Date: Sep. 22, 2011

(54) Method of formatting text in an electronic document to increase reading speed

(75) Inventor: Daniel Herzner, White Plains, NY (US)

(73) Assignee: Daniel Herzner, White Plains, NY (US)

(21) Appl. No.: 12/472,516

(22) Filed: May 27, 2009

Related U.S. Application Data
(60) Provisional application No. 61/134,703, filed on Jul. 14, 2008.

(51) Int. Cl. G06F 17/00

(52) U.S. Cl. 715/256

(57) ABSTRACT

A formatting/publishing method according to the present invention blends the concept of reading backwards to improve reading speed with rendering every other line of paragraph text backwards so that reading backwards actually makes sense. Each word in a line of text printed backwards is right reading but the words themselves are rendered from right to left (backwards). This enables the person reading a document published using the formatting technique of the present invention to read in a zigzag fashion in a pragmatic way. Every first line of a paragraph is rendered in a traditionally published format (read from left to right). Therefore, every odd numbered line in a paragraph is always rendered from left to right and every even numbered line is always rendered backwards (read from right to left).

### CROSS-REFERENCE TO RELATED APPLICATION

The present application claims the benefit of U.S. patent application No. 61/134,703, filed Jul. 14, 2008.

### TECHNICAL FIELD

The present application relates to the creation of electronic documentation and in particular, relates to a method of presenting text in an electronic document that improves reading speed.

### BACKGROUND

Traditional publishing methods dictate that each individual line of reading material printed in the English language is read from left to right. When an individual completes the reading of a row of words they must drag their eye back across the page from right to left to begin reading the next row. The wider the page, the longer the sentence, the more difficult and tiresome traditional reading becomes. This is especially true when reading documents rendered on a computer screen. A visual representation of this conventional reading style is illustrated in FIG. 1.

Many speed reading instructors and courses encourage “backwards reading” as one way of accelerating one's reading speed. They reason that reading backwards can shave, on average, a few seconds off of your reading time for each row of words. This time saved can add up significantly when considering the number of rows of words on a single page and the number of pages in a single book. A visual representation of the “backwards reading” technique is illustrated in FIG. 2.

Reading backwards does save a significant amount of time which translates into significantly faster reading. However, there is one colossal drawback to backwards reading; namely, it is extremely confusing and difficult and most people are incapable of doing it efficiently. And, the longer a row of words, the more challenging this becomes.

As a result of the above deficiencies, there is a need for an improved method of increasing reading speed especially for documents presented in electronic form.

### SUMMARY

The present invention is directed to a method of presenting text in an electronic document (Easy Reader Publishing Model) and thus, the method is for use in the creation of electronic documentation. Specifically, the method according to the present invention is capable of improving anybody's reading speed by up to 40% regardless of current reading skill. This improvement in reading speed is attained almost instantly without the need for expensive, time consuming courses or study material. The method of the present invention can be implemented with astonishing results. The effectiveness of the present invention does not lie in the scholastic aptitude of the individual but rather in the formatting of how reading material is published or rendered. Thus, the present invention is directed to a formatting technique that results in the presentation of the text in a different format compared to conventional left-to-right presentation and one that permits reading speeds to increase. Therefore, improved reading speed of electronic documents is available to all regardless of economic circumstances, time constraints or current reading skills.

The necessity and frustration of purchasing expensive courses and spending hour upon hour “practicing” speed reading techniques is obviated under the method of presenting text according to the present invention (Easy Read Publishing Model). What's most exciting about the present invention is that people need to only slightly tweak the way they've been trained to read all their lives. All that is required to improve reading speed, and interest in reading itself, is for someone to open an electronic document that has been published and formatted using the method according to the present invention.

The key to the success of the present method is that it places negligible onus on the individual with the majority on the way in which reading material is published.

### BRIEF DESCRIPTION OF THE DRAWING FIGURES

FIG. 1 is a visual representation of a conventional left-to-right publishing method where words in each line are read from left-to-right;

FIG. 2 is a visual representation of a conventional “backwards reading” technique;

FIG. 3 is a visual representation of the presentation of text according to the method of the present invention;

FIG. 4 is a visual representation of two consecutive paragraphs formatted in accordance with the method of the present invention; and

FIG. 5 is a visual representation of a paragraph formatted in accordance with the method of the present invention and including a page break therein.

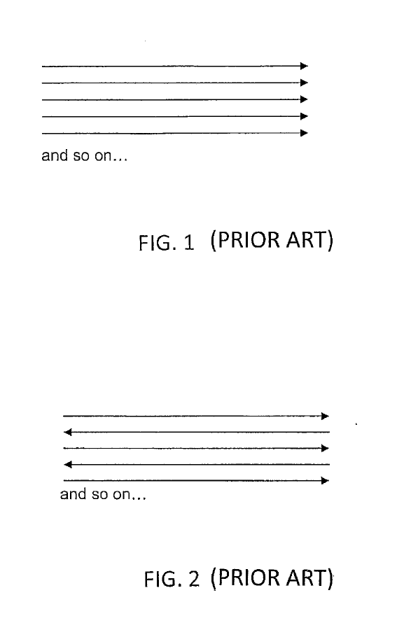

### DETAILED DESCRIPTION OF THE PRESENT INVENTION

In accordance with the present invention, a method of formatting text, especially in an electronic document, is presented. The publishing method of the present invention takes advantage of the speed gained in reading a row of text backwards and blends it with the ability to actually understand what is being read. Therefore, the time that can be gained in reading every other row of text backwards can be realized in a sensible, pragmatic and useful way. This can be made possible by using the formatting and publishing technique of the present invention (Easy Reader Publishing Model) which prints every other row of text backwards making reading the backwards row just as easy as reading a row left to right.

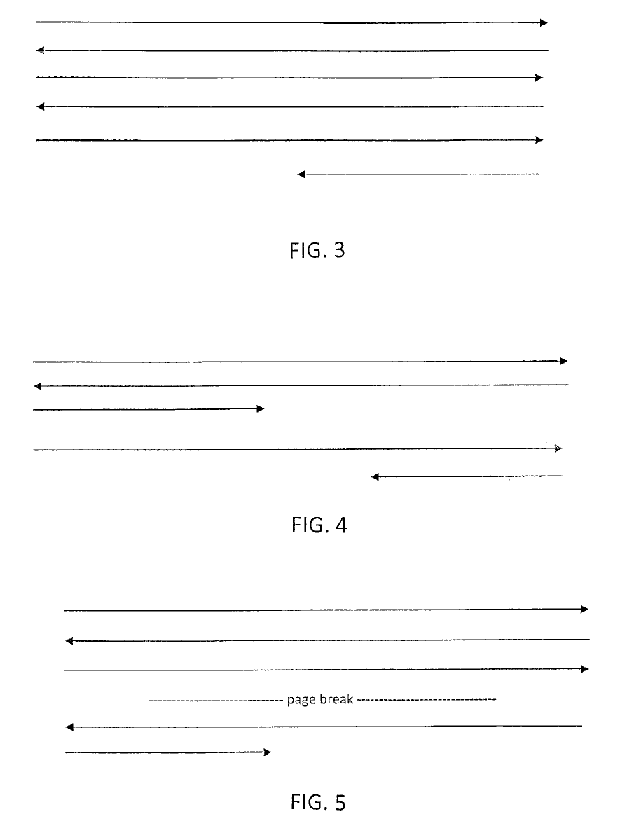

FIG. 3 is a visual representation of the formatting/presentation method according to the present invention. Each line in FIG. 3 indicates the direction of a line of text within a paragraph published using the formatting method of the present invention. Every odd numbered line is rendered right reading (read from left-to-right) and every even numbered line is rendered in the formatting of the present invention where the text is read from right-to-left. The last line is rendered backwards (read right-to-left) and is right justified.

FIG. 4 represents two consecutive paragraphs in a document published using the formatting published in accordance with the present invention. Even though the final line of the first paragraph is rendered right reading (from left-to-right), the first line of the second paragraph is also rendered right reading (from left-to-right).

FIG. 5 represents a paragraph within a document published under the formatting technique of the present invention and where the paragraph has been broken up by a page, break. The first line of the new page, which is the fourth line of a complete paragraph, is rendered backwards (from right to left).

### Example

So far you've been reading this document in the traditional fashion and you've had little choice since it was published to be read that way. Now, read the following three paragraphs taken from Robert Kiyosaki's book entitled “Before You Quit Your Job”. These three paragraphs have been rendered using the formatting technique of the present invention (Easy Reader Publishing Model). This excerpt was chosen because it contains a variety of elements frequently found throughout published material (commas, colons, parenthesis, etc).:
When entrepreneurs make a mistake, they typically do not fixate on the consequences mistake the making that concerned particularly not are typically They .mistake the of might make them look bad. The true entrepreneur focuses instead on learning form the avoid you do How ?mistake the form resulting problems any solve you do How .mistake making the mistake in the future? How do you minimize the adverse consequences of the on capitalize to way a there Is ?future the in again occur does it if mistake the mistake and turn it into an advantage?
How do you capitalize on a mistake? I like to think in terms of turning problems into opp—or avoid to how—it for solution a with up come and problem a identify You .ortunities minimize the consequences of the mistake. That solution may well be a valuable asset be can which or built be can business a which around (property intellectual called often) used as a tool to grow your existing business. Of course, you would want to put legal greatest the to solution that to rights exclusive have you that so place in protection extent possible.
For example, let's take a trip back through time and assume that you were in the way hard the out found You .radios transistor first the of one developing of process that if you made a mistake in the way that you connected the battery to the circuit point that At .smoke in up go to tendency a had transistors the, (polarity the reversed) in time, transistors were very expensive, and it was a costly mistake. But you learned a with plug a :solution a with up come and—problem a identify You .mistake the from key that prevents it from being inserted the wrong way. Assume that you are able to could you that think you Do .problem the to solution your on protection patent obtain build a business around the solution to that mistake?

The above paragraphs represent the formatting/publishing method of the present invention.

In different embodiments, the formatting/publishing method of the present invention can have the following characteristics: (1) Every odd numbered lines of a paragraph is always rendered right reading (i.e., read from left-to-right); (2) Every even numbered line of a paragraph is always rendered backwards with the words themselves right reading (i.e., each word reads left-to-right with the line of words being read right-to-left)(this format is known herein as the Easy Reader Format); (3) All paragraphs begin with a right reading line regardless of whether or not the final line of the previous paragraph was right reading; (4) If the first line of a new page happens to be an even numbered line from a paragraph initiated on the previous page, that line will be rendered in the Easy Reader Format; (5) Single sentence paragraphs which do not extend beyond a single line are always rendered right reading; (6) if the final line of a paragraph is even numbered (rendered in Easy Reader Format) then just that line—not the entire paragraph—will be right justified; (7) all punctuation where required will always be rendered right reading when appearing in a line rendered under the Easy Reader Format. For example, if the line “What is your name?” is rendered under the Easy Reader Format, it would appears as “? name your is What” with the question mark being right reading; (8) A single word made up of two seemingly separate words is always wholly rendered right reading. For example, the phrase “look at the hoi polloi” rendered in Easy Reader Format would be published as “hoi polloi the at look”.; (9) A single word made up of two words held together with a hyphen is always rendered right reading. For example, the phrase “you must opt-in” rendered in Easy Reader Format would be published as “opt-in must you”.; (10) If a line rendered in Easy Reader Format contains a phrase in parenthesis, the opening parenthesis will be a right parenthesis and the closing parenthesis will be a left parenthesis. For example, the line:

I love chocolate ice cream (just in case you were wondering) with sprinkles.

would be rendered in Easy Reader Format as:

.sprinkles with (wondering were you case in just) ice cream chocolate love I; (11) If a mid sentence phrase enclose in parenthesis begins with a right reading line and concludes in the following line rendered in Easy Reader Format, the opening parenthesis will be a left parenthesis and the closing parenthesis will be a left parenthesis; (12) Numbered rendered in Easy Reader Format are always right reading with right reading placement of dollar sign and decimal point. For example, the line:

I made $10,000.00 last month.

would be rendered in Easy Reader Format as:

.month last $10,000.00 made I

The present invention thus has particular utility in presenting documentation, such as books, in electronic form and in a manner that allows the reader to dramatically increase his/her reading speed.

1-24. (canceled)

25. A method of formatting text that is presented in a document
comprising:
presenting text in odd numbered lines of a paragraph in a right reading format in that the text is read from left-to-right, wherein the text is defined by a plurality of words; and
presenting text in even numbered lines of the paragraph in a backwards format such that a line of words that define the text is read right-to-left; however, each individual word in the even numbered line is read left-to-right.

26. The method of claim 25, wherein punctuation in both the odd and even numbered lines is always presented in right reading format.

27. The method of claim 25, wherein an expression that is formed of two words that are held together with a hyphen is always rendered in right reading format.

28. The method of claim 25, wherein if an even numbered line contains a phrase in parenthesis, an opening parenthesis is a right parenthesis and a closing parenthesis is a left parenthesis.

29. The method of claim 25, wherein a number appearing in an even numbered line is always rendered in right reading format with right reading placement of a dollar sign and decimal point.

30. The method of claim 25, wherein the document is an electronic document.

31. The method of claim 25, wherein a first line of a paragraph is always treated as an odd numbered line.

32. The method of claim 25, wherein if a final line of the paragraph is even numbered, then just the final line of the paragraph and not the entire paragraph is right justified.

33. An electronic publishing format for a document that is presented in electronic form comprising:
at least one paragraph having at least one odd numbered line and at least one even numbered line, wherein a line of words in odd numbered lines of the paragraph is presented in a right reading format in which the line of words is read from left-to-right, wherein a line of words in even numbered lines of the paragraph is presented in a right-to-left reading format; however, each individual word in the even numbered line is read left-to-right.

34. The electronic publishing format of claim 33, wherein punctuation in both the odd and even numbered lines is always presented in right reading format.

35. The electronic publishing format of claim 33, wherein an expression that is formed of two words that are held together with a hyphen is always rendered in right reading format.

36. The electronic publishing format of claim 33, wherein if an even numbered line contains a phrase in parenthesis, an opening parenthesis is a right parenthesis and a closing parenthesis is a left parenthesis.

37. The electronic publishing format of claim 33, wherein a number appearing in an even numbered line is always rendered in right reading format with right reading placement of a dollar sign and decimal point.

38. The electronic publishing format of claim 33, wherein the document is an electronic document.

39. The electronic publishing format of claim 33, wherein a first line of a paragraph is always treated as an odd numbered line.

40. The electronic publishing format of claim 33, wherein if a final line of the paragraph is even numbered, then just the final line of the paragraph and not the entire paragraph is right justified.
